(19) United States
(12) Patent Application Publication
(10) Pub. No.: US 2005/0012663 A1
(43) Pub. Date: Jan. 20, 2005

(54) System for locating a person having fallen overboard

(76) Inventors: James Audren, Cleguer (FR); Philippe Renaudin, Lorient (FR)

Correspondence Address: James H Patterson;Patterson Thuente Skaar & Christensen, 4800 IDS Center, 80 South 8th Street, Minneapolis, MN, 55402, US

(21) Appl. No.: 10/495,202

(22) PCT Filed: Nov. 6, 2002
(86) PCT No.: PCT/FR02/03791

(30) Foreign Application Priority Data
Nov. 12, 2001 (FR) 01/14685

(51) Int. Cl. G01S 5/14

(52) U.S. Cl. 342/357.07

(57) ABSTRACT

The invention concerns a system for locating a person having fallen overboard. Said system is designed for participants in a race on the open sea. The inventive system is in the form of a clothing article worn by said person having fallen overboard and a receiver module on board the boat. The clothing article comprises a floater forming an upwards-oriented column when inflated. Additionally, there is provided in the clothing article, a radio transmitter associated with the receiver module and a GPS receiver for determining the position of said person overboard. The GPS receiver and the radio transmitter are arranged in the free end of the column. The GPS position of the person overboard is transmitted to the receiver module (4) by the radio transmitter.

This invention relates to a system for locating a person having fallen overboard. This system is intended for use particularly by participants in a race on the open sea, and particularly for crew members of a boat.

During a race in the open sea, every crew member may be equipped with a belt called a safety belt, provided with a floater in the form of a ring that inflates around the sailor's waist as it comes into contact with the water when he falls overboard. This inflatable belt is designed to keep the sailor on the surface of the water. Wearing this type of belt has an advantage over wearing a life jacket, in that it hinders the crew member less in his movements during manoeuvres on the boat. To make it easy to determine his position, the man overboard can be provided with a SARSAT type distress beacon in his belt that he triggers himself or that is triggered automatically when he falls overboard. Triggering of the distress beacon is then detected by satellite and the position of the man overboard is then communicated through a surveillance centre to the boat concerned. However, this means of identifying the position of the man overboard is not very suitable for emergency situations such as the recovery of a man overboard since several minutes, or even several tens of minutes, elapse between when the distress beacon is triggered and when the boat receives the position information.

Instead of the SARSAT type distress beacon, it would be possible to place a transmitter in the belt capable of emitting a distress signal to a receiver placed onboard the boat to notify the skipper that one of his crew members has fallen overboard. Reception of the distress signal may for example trigger an alarm onboard the boat. The man overboard is provided with a fluorescein cartridge to colour the water and/or an electronic-flash lamp and/or a whistle, so that he can be found. However, these location finding means are not always very efficient in heavy weather or when the waves are large.

Thus, the purpose of the invention is to make a simple, reliable, efficient and economic system for locating a man fallen overboard. This system must also introduce the least possible constraints in terms of weight and hindrance in movements of the person who wears it, so that he is not tempted to take it off during the race to have greater freedom in his movements.

The basic concept of the invention consists of fitting a GPS receiver in the belt to determine the position of the man overboard and to notify this position through a radio transmitter to a receiver module onboard the boat.

However, this solution causes a problem: if the GPS receiver is to be able to calculate its position correctly, it must be in direct sight with at least three satellites. This is not usually the case when the GPS receiver is at the waist of a man overboard since the immersed part of the body of the man overboard prevents this direct line of sight to satellites. If the GPS receiver is under water, it is totally impossible to receive the GPS signals.

Thus, the invention relates to a system for locating a man having fallen overboard, comprising an article of clothing worn by the said man overboard and provided with a radio transmitter associated with a receiver module placed onboard the said boat,
characterised in that the said article of clothing is also provided with a GPS receiver to produce a signal representing the position of the said man overboard, the said signal is transmitted by the said radio transmitter to the said receiver module,
and in that the said article of clothing comprises a floater forming, when inflated, an upwards-oriented column to project above the head of the said man overboard,
and in that the said radio transmitter and the said GPS receiver are placed in the free end part of the said column.

The column positions the GPS receiver and the radio transmitter a few tens of centimetres above the water surface. The GPS receiver may thus easily receive GPS signals from at least three satellites. Transmission to the boat receiver module is also improved.

The article of clothing may for example be a belt that the said man overboard wears around his waist, a life jacket or a waxed jacket.

According to one preferred embodiment, the radio transmitter and the radio receiver are not powered until the belt floater is sufficiently inflated.

Advantageously, the receiver module compares the position of the man overboard with the position of the boat after reception of the signal representing the position of the said man overboard, to determine the required heading and the distance to be travelled to reach the said man overboard.

Other aspects, details of embodiments and advantages of the invention will become clear after reading the following description with reference to the following figures:

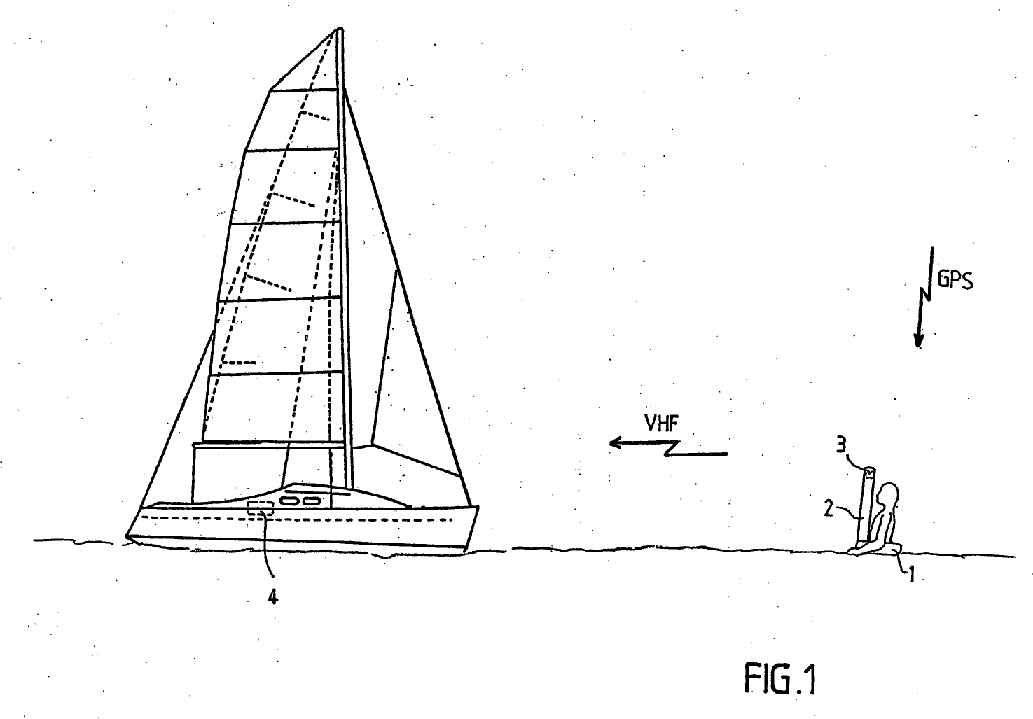

FIG. 1 shows a general view illustrating an embodiment of the system according to the invention in an operating situation;

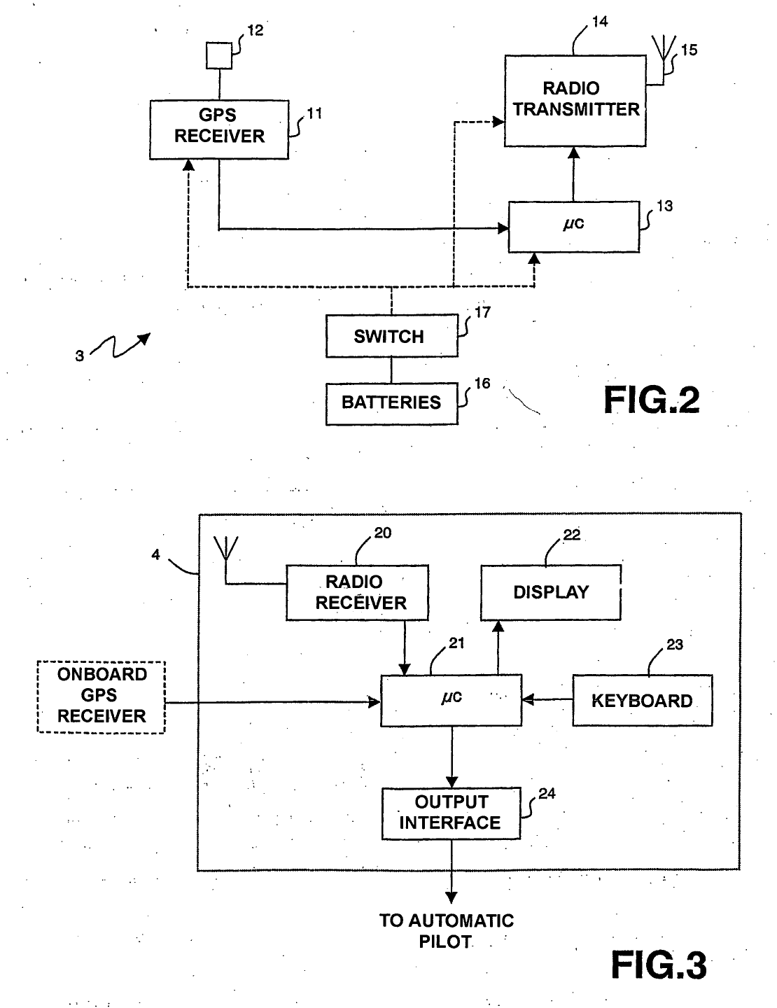

FIG. 2 shows a block diagram of the electronic circuit for the article of clothing of the system according to the invention;

FIG. 3 shows a block diagram of the receiver module of the system according to the invention, and

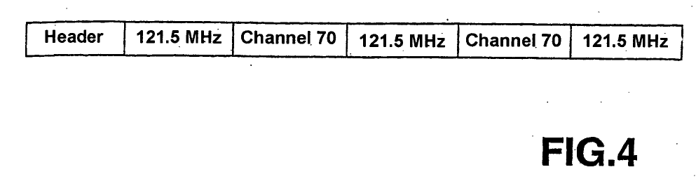

FIG. 4 shows the structure of a frame emitted by the radio transmitter of the article of clothing of the system according to the invention.

The system according to the invention is in the form of an article of clothing that the sailor wears and a fixed or mobile receiver module placed onboard the boat. The article of clothing is essentially provided with a floater, a GPS receiver and a radio transmitter. When the sailor falls overboard, the floater inflates and forms an upwards-oriented column above or level with the head of the sailor. The radio transmitter and the GPS receiver are then switched on and the radio transmitter transmits the position supplied by the GPS receiver to the boat receiver module.

FIG. 1 illustrates an embodiment of the system according to the invention. In this embodiment, the article of clothing is a belt. This belt comprises:
a floater composed of an inflatable base 1 in the form of a ring with an appendix 2 forming an upwards-oriented column when inflated, and rising above the head of the sailor;
a gas cartridge (not shown), for example a CO2 cartridge provided with a manual and automatic striker, to inflate the said floater when the sailor falls overboard;
a leaktight housing enclosing an electronic circuit 3 comprising essentially a GPS receiver, a microcontroller, a radio transmitter, a pressure sensitive switch and batteries; this housing is placed in a pocket fixed to the free end part of the column.

The height of the floater column is about 40 to 60 centimetres, and its purpose is to keep the electronic housing clear out of the water and above the head of the man at sea so that the GPS receiver is in direct line of sight of at least three satellites. The ring-shaped base of the floater keeps the man who has fallen overboard on the surface of the water.

A block diagram of the electronic circuit 3 is shown in FIG. 2. The electronic circuit 3 comprises the GPS receiver 11 provided with a patch type antenna 12 to calculate the position of the man overboard, a microcontroller 13 to code position information originating from the GPS receiver and a radio transmitter 14 provided with an antenna 15 to transmit the said coded position information (in the form of VHF signals) to the boat receiver module. Electric cells or batteries 16 are provided to power all elements of the electronic circuit through a switch 17 sensitive to pressure inside the floater. The switch 17 is provided to control switching the GPS receiver 11, the microcontroller 13 and the radio transmitter 15 on when the pressure inside the floater is greater than a predetermined threshold. Thus, the electronic circuit 3 is not switched on until the floater is sufficiently inflated. In practice, a small tube with a diameter of a few millimetres is used to transmit the internal pressure in the floater to the switch 17 located on the card of the electronic circuit. This switch 17 has the advantage that it only switches the electronic circuit 3 on when the housing is in position to receive GPS signals.

As a variant, instead of the pressure switch, it would be possible to use a switch controlled by the sudden temperature drop on the neck of the gas cartridge when it is struck. In this case, the switch may for example be a shape memory contact or a thermistance.

It would also be possible to control the switch 17 manually, and the switch would then be a conventional switch.

The receiver module onboard the boat, reference 4 in FIG. 1, comprises mainly a radio receiver fixed to the frequency of the radio transmitter 15 and a microcontroller in relation with the GPS receiver on the boat to determine the heading to be followed and the distance to be travelled to retrieve the man having fallen overboard.

An example structure of the receiver module 4 is given in FIG. 3. This module includes a radio receiver 20 to receive VHF signals from the transmitter 15 and to transmit them to a management microcontroller 21 to decode them. The microcontroller 21 receives the position of the boat from the GPS receiver on the boat. It then calculates the heading to be followed and the distance to be travelled to retrieve the man overboard. It displays this information on a screen 22. This information is displayed and recalculated continuously as the boat approaches the man overboard. Advantageously, the position of the man overboard is also displayed on the screen.

If the GPS receiver of the boat is not directly connected to the management microcontroller 21, a keyboard 23 can be provided to input the position given by the GPS receiver of the boat.

Depending on the heading to be followed and the distance to be travelled, the microcontroller 21 outputs control signals to an output interface 24, for example to control the automatic pilot of the boat. These control signals may also be used to trigger an alarm signal, jettisoning of a buoy or lighting of a flash located on the top of the boat mast.

Thus, the system according to the invention operates as follows: as soon as the person wearing the belt falls overboard, the floater automatically inflates on contact with the water, thus bringing the electronic housing 3 above the water. The floater inflation may be controlled manually if the automatic striker did not operate. An oral inflation tube may also be provided to inflate the floater to circumvent a deficiency in the gas cartridge or the striker, or to top up insufficient inflation. The GPS receiver 11 then determines the position of the man overboard and transmits it through the radio transmitter 15 to the receiver module 4. The microcontroller 21 then decodes the received information and displays the position of the man overboard on the screen 22. Preferably, the microcontroller then compares this position information with the position information of the boat to determine the navigation information necessary to retrieve the man fallen overboard.

To improve visual location finding of the man overboard, it would be possible to provide a lamp powered by the electronic circuit 3 at the top of the column when the boat approaches it.

There are several possible solutions for the VHF link between the transmitter 15 and the receiver 20:
use of the 121.5 MHz frequency;
use of channel 70 (IEC standard 1097-3);
use of the 406 MHz distress frequency (IEC standard 1097-2);
use of a frequency within the X band between 9.2 and 9.5 GHz (IEC standard 1097-1).

According to one preferred embodiment, the radio transmitter 15 alternately transmits a distress signal at frequency 121.5 MHz to be located by a monitoring satellite, and a coded message on channel 70 to be picked up by the receiver 20. In one example illustrated in FIG. 4, the transmitter 15 transmits a header signal on channel 70 to identify the man overboard, followed by a distress signal at frequency 121.5 MHz to the satellite, a first coded message on channel 70, a second distress signal at frequency 121.5 MHz, a second message coded on the channel 70, and a last distress signal at frequency 121.5 MHz. The coded messages may be different or identical. Advantageously, these three messages are identical and contain position information supplied by the GPS receiver 11.

For information, the transmission parameters on channel 70 are as follows:
Frequency: 156.025 MHz
Frequency modulation: 400 Hz
Sub-carrier 1700 Hz (1300-2100±110 Hz)
Modulation speed 1200 bauds.

Obviously, the invention is not limited to the particular embodiment that has just been described. Those skilled in the art could easily imagine many variant embodiments of the system, for example using a life belt, wax jacket or working overalls for sea professionals, as the article of clothing. The article of clothing may also be a safety belt without a ring-shaped floater.

In one particular application for divers, the system may be used with an unwinder provided with a cable about a hundred meters long. This cable connects the inflatable column to the diver's wet suit or safety belt. When the diver is in difficulty underwater, he triggers inflation of the column that rises to the surface with the electronic circuit. In this application, the electronic circuit is only powered when the column has reached the surface. For example, this is done by delaying switching the electronic circuit on by a predetermined duration (for example about ten seconds) after the end of inflation of the column.

1. A system for locating the position of a person having fallen overboard from a boat, comprising an article of clothing worn by the person and provided with a radio transmitter associated with a receiver module placed onboard the boat,
the article of clothing being provided with a GPS receiver to produce a signal representing the position of the person overboard, the signal being transmitted by the radio transmitter to the receiver module,
the article of clothing comprising a floater forming, when inflated, an upwards-oriented column having a free end adapted to project above the head of the person overboard,
the radio transmitter and the GPS receiver being placed in the free end part of the column.

2. A system according to claim 1, including a gas cartridge provided with a manual and/or automatic striker on the article of clothing, to inflate the said floater when the person wearing the article of clothing falls overboard.

3. A system according to claim 1, the article of clothing including a microcontroller to code the signal representing the position of the person overboard.

4. A system according to claim 3, the article of clothing including batteries to power the GPS receiver, the radio transmitter and the microcontroller, through a switch.

5. A system according to claim 4, the switch adapted to be sensitive to the internal pressure of the floater, the switch being closed when the internal pressure of the floater is greater than a predetermined threshold.

6. A system according to claim 4, wherein the switch closes following a sudden temperature drop on the neck of the gas cartridge.

7. A system according to claim 1, wherein the article of clothing is a belt that the person overboard wears around their waist.

8. A system according to claim 7, the floater including a base in the form of a ring that inflates around the waist of the person fallen overboard to keep the person on the surface of the water.

9. A system according to claim 1, wherein the article of clothing is a life jacket.

10. A system according to claim 1, wherein the receiver module onboard the boat comprises a radio receiver to receive the signal transmitted by the radio transmitter and a microcontroller to display the position of the person overboard on a visual display.

11. A system according to claim 10, wherein the microcontroller of the receiver module compares the position of the person overboard with the position of the boat to determine the heading to be followed and the distance to be travelled to reach the person overboard.

12. A system according to claim 11, wherein the heading to be followed and the distance to be travelled are supplied to an automatic piloting device on the boat.
